(19) United States
(12) Patent Application Publication
(10) Pub. No.: US 2026/0268841 A1
(43) Pub. Date: Sep. 10, 2026

(54) DISPLAY METHOD FOR DISPLAY DEVICE AND DISPLAY DEVICE

(71) Applicant: Wuhan Tianma Microelectronics Co., Ltd., Wuhan (CN)

(72) Inventors: Junjie AN, Wuhan (CN); Panpan LI, Wuhan (CN)

(73) Assignee: Wuhan Tianma Microelectronics Co., Ltd., Wuhan (CN)

(21) Appl. No.: 19/656,644

(22) Filed: Apr. 23, 2026

(30) Foreign Application Priority Data
Nov. 7, 2025 (CN) 202511632763.2

(51) Int. Cl. G09G 3/3208

(52) U.S. Cl. CPC G09G 3/3208; G09G 2320/0233; G09G 2320/043; G09G 2320/06; G09G 2358/00

(57) ABSTRACT

Provided are a display method for a display device and a display device. The display device has a first display mode and a second display mode, where the display non-uniformity compensation data corresponding to the first display mode and the second display mode are different. The display device includes a display panel and a display driver chip that includes a storage unit configured to store at least the display non-uniformity compensation data. The display method includes: acquiring, by the display driver chip, the display non-uniformity compensation data stored in the storage unit according to a to-be-displayed image of the display panel, to perform display non-uniformity compensation on a display image of the display panel, where during a process of mutual switching between the first display mode and the second display mode, turn-off time of the display non-uniformity compensation of the display device is less than 40 ms.

### CROSS-REFERENCE TO RELATED APPLICATIONS

This application claims priority to Chinese Patent Application No. 202511632763.2, filed on November 07, 2025, which is hereby incorporated by reference in its entirety.

### TECHNICAL FIELD

The present disclosure relates to the field of display technologies, and in particular relates to a display method for a display device and a display device.

### BACKGROUND

At present, with the continuous development of display technologies, the display quality of a display screen is getting better and better, and the response speed of a display image is also getting higher and higher. In addition to traditional display devices such as televisions, computers and mobile phones, other application scenarios of display screens are also expanding continuously, such as being gradually widely applied to in-vehicle displays and smart wearable devices. For privacy and security considerations, the demand for the privacy protection function of display screens is growing in certain application scenarios. Therefore, existing display devices generally provide two modes for users to choose from, namely the wide-viewing-angle mode (shared display) and the narrow-viewing-angle mode (privacy protection display).

Currently, display driver chips (display driver ICs, DDICs) usually cooperate with the complete machine side to complete display mode switching. However, during the mode switching process of existing display devices, within the period from the issuance of a switching instructions to the completion of mode switching, some functions for compensating the display image are in the OFF state. As a result, users can clearly perceive display mura, leading to poor viewing experience and affecting overall user experience.

### SUMMARY

To address the above technical problems, the present disclosure provides a display method for a display device and a display device, aiming to solve the problems in existing display devices where display mura is easily perceived by users during display mode switching to result in poor user experience and satisfaction.

The present disclosure provides a display method for a display device. The display device has a first display mode and a second display mode, where display non-uniformity compensation data corresponding to the first display mode is different from display non-uniformity compensation data corresponding to the second display mode. The display device includes a display panel and a display driver chip, the display driver chip includes a storage unit, and the storage unit is configured to store at least the display non-uniformity compensation data corresponding to the first display mode and the display non-uniformity compensation data corresponding to the second display mode. The display method includes: acquiring, by the display driver chip, the display non-uniformity compensation data corresponding to the first display mode and the display non-uniformity compensation data corresponding to the second display mode stored in the storage unit according to a to-be-displayed image of the display panel; and performing display non-uniformity compensation on the display image of the display panel, where during a mutual switching process between the first display mode and the second display mode, turn-off time of the display non-uniformity compensation of the display device is less than 40 ms.

Based on the same inventive concept, the present disclosure also provides a display device, which adopts a display method for displaying. The display device has a first display mode and a second display mode, where display non-uniformity compensation data corresponding to the first display mode is different from display non-uniformity compensation data corresponding to the second display mode. The display device includes a display panel and a display driver chip, the display driver chip includes a storage unit, and the storage unit is configured to store at least the display non-uniformity compensation data. The display method includes: acquiring, by the display driver chip, the display non-uniformity compensation data stored in the storage unit according to a to-be-displayed image of the display panel, to perform display non-uniformity compensation on the display image of the display panel, where during a mutual switching process between the first display mode and the second display mode, turn-off time of the display non-uniformity compensation of the display device is less than 40 ms.

Compared with the related art, the technical solutions provided in the embodiments of the present disclosure have the following advantages.

The display device provided by the present disclosure may be an organic light-emitting diode (OLED) display device. When the display product is designed with two different display modes, two sets of different pixel driving methods are usually required to drive pixels to emit light. Moreover, due to factors such as differences in the materials of organic light-emitting units and inconsistent usage durations of different modes during user operation, theoretically, the two display modes generally need to generate respective display non-uniformity compensation data according to their respective mura states and usage durations during pixel driving. That is, when the display device includes the first display mode and the second display mode, the display non-uniformity compensation data corresponding to the first display mode is different from the display non-uniformity compensation data corresponding to the second display mode, so as to adapt to their respective pixel driving methods and improve the display effect under different display modes. The display device of the present disclosure includes a display panel and a display driver chip, where the display driver chip is used to cooperate with the complete machine end to complete the switching of the display modes of the display device during the display process. The display driver chip may generally include a storage unit, which is used to store at least the display non-uniformity compensation data. In the display method provided by the present disclosure, in either the first display mode or the second display mode, the display driver chip acquires the currently stored display non-uniformity compensation data in the storage unit according to the to-be-displayed image of the display panel, to perform display non-uniformity compensation on the display image of the display panel; in addition, during the mutual switching process between the first display mode and the second display mode, the turn-off time of the display non-uniformity compensation of the display device is less than 40 ms. By shortening the turn-off time of the display non-uniformity compensation during the mutual switching between the first display mode and the second display mode to less than 40 ms, the switching between the two display modes can be completed within a time period where the human eye cannot perceive the flicker. This can weaken the visual effect difference in the mode switching phase to a certain extent, solve the problem of obvious mura state changes in current display products during display mode switching, achieve seamless switching as much as possible, and improve user experience.

### BRIEF DESCRIPTION OF DRAWINGS

The accompanying drawings herein are incorporated in and constitute a part of the present specification, which illustrate embodiments consistent with the present disclosure and together with the specification, serve to explain the principles of the present disclosure.

To more clearly illustrate the technical solutions in the embodiments of the present disclosure or the related art, the accompanying drawings required for describing the embodiments or the related art will be briefly introduced below. Those of ordinary skill in the art can obtain other drawings based on these drawings.

FIG. 1 is a schematic structural diagram of a display device provided in some embodiments of the present disclosure;

FIG. 2 is a flowchart of a display method for a display device in FIG. 1;

FIG. 3 is another schematic structural diagram of a display device provided in some embodiments of the present disclosure;

FIG. 4 is a flowchart of a display method for a display device in FIG. 3;

FIG. 5 is another flowchart of a display method for a display device in FIG. 3;

FIG. 6 is another flowchart of a display method for a display device in FIG. 3;

FIG. 7 is another flowchart of a display method for a display device in FIG. 3;

FIG. 8 is another schematic structural diagram of a display device provided in some embodiments of the present disclosure;

FIG. 9 is a flowchart of a display method for a display device in FIG. 8;

FIG. 10 is another schematic structural diagram of a display device provided in some embodiments of the present disclosure;

FIG. 11 is a flowchart of a display method for a display device in FIG. 10;

FIG. 12 is a schematic diagram of a flow of a display method in FIG. 11;

FIG. 13 is a flowchart of switching a first display mode to a second display mode in a display method for a display device in FIG. 10;

FIG. 14 is a flowchart of switching a second display mode to a first display mode in a display method for a display device in FIG. 10;

FIG. 15 is a schematic diagram of a flow of a display method in FIG. 13; and

FIG. 16 is another schematic diagram of a flow of a display method in FIG. 13.

### DESCRIPTION OF EMBODIMENTS

To better illustrate the aforesaid objectives, features and advantages of the present disclosure, the solutions of the present disclosure will be further described below. It should be noted that the embodiments of the present disclosure and the features in the embodiments may be combined with each other.

Numerous specific details are set forth in the following description to facilitate better illustration of the present disclosure, however, the present disclosure may also be implemented in other manners different from those described herein. Obviously, the embodiments described in the specification are merely some rather than all of the embodiments of the present disclosure.

It has been found that various processes involved in the production of display products may cause mura phenomena in the display image. The mura phenomenon refers to a phenomenon where the brightness within the display panel is not uniform, resulting in various visible marks on the screen. Failure to compensate for the mura phenomenon will exert a significant negative impact on the display quality of the image. At present, some display devices adopt the Demura compensation (i.e., display non-uniformity compensation) method during the display process to mitigate the mura phenomenon and optimize display quality.

Demura compensation refers to a technique that corrects the non-uniformity of screen brightness or chromaticity (i.e., mura defects) by means of compensation algorithms, to improve the uniformity of image quality. During the implementation of Demura compensation, a CCD camera is typically used to collect the brightness of the current display device at several specific grayscale levels, and based on the collected grayscale-brightness corresponding values, the mura information within the panel is obtained. Then, the mura information is extracted and corrected through specific algorithms, and compared with the target gamma curve values, a compensation table (Demura Table) is finally constructed. The constructed compensation table is compressed and burned into a flash memory chip (e.g., Flash), for interpolation, retrieval, loading and storage by hardware components (such as a processor) in the display driver IC (DDIC). The display driver IC decompresses the compensation table to perform compensation for the specific grayscale levels. As for mura defects at other grayscale levels, the compensation values of the specific grayscale levels are weighted, and the compensation amounts for other grayscale levels are adjusted according to the actual display effects.

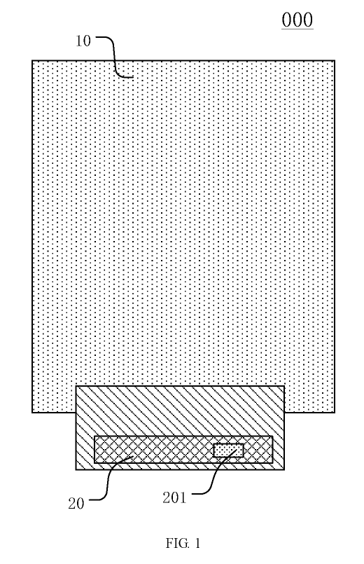

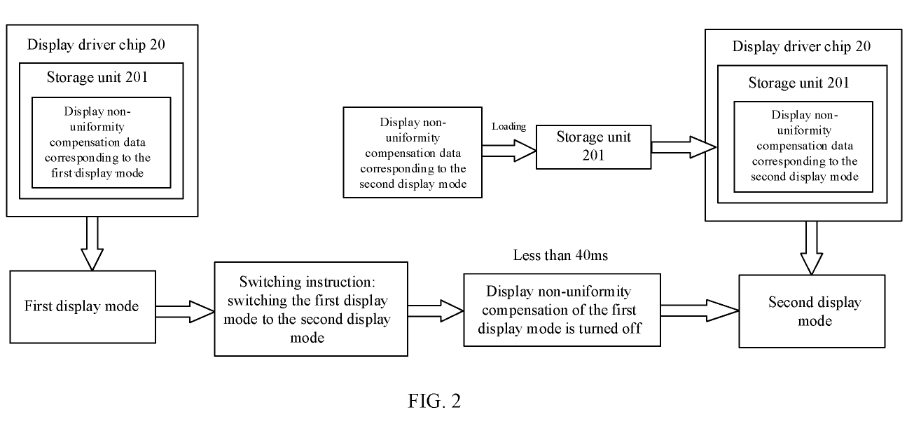

Please referring to FIG. 1 and FIG. 2, where FIG. 1 is a schematic structural diagram of a display device provided in an embodiment of the present disclosure, and FIG. 2 is a flowchart of a display method for the display device in FIG. 1, the display method for a display device provided in an embodiment is applicable to a display device 000, which has a first display mode and a second display mode, where the display non-uniformity compensation data corresponding to the first display mode and the second display mode are different. The display device 000 includes a display panel 10 and a display driver chip 20, the display driver chip 20 includes a storage unit 201, and the storage unit 201 is configured to store at least the display non-uniformity compensation data.

The display method includes the following process: the display driver chip 20 acquires the display non-uniformity compensation data stored in the storage unit 201 according to the to-be-displayed image of the display panel 10, to perform display non-uniformity compensation on a display image of the display panel 10, where during the mutual switching process between the first display mode and the second display mode, the turn-off time of the display non-uniformity compensation of the display device 000 is less than 40 ms.

In an example, the display device provided in the embodiments may be an OLED (organic light-emitting diode) display device. When an OLED display product is designed with two different display modes, two different driving methods are usually required to drive the pixels to emit light. Moreover, due to factors such as differences in OLED light-emitting units and inconsistent usage durations of different modes during user’s operation, theoretically, the two display modes generally need to generate respective Demura compensation data according to their respective mura states and usage durations during pixel driving. That is, when the display device 000 includes the first display mode and the second display mode, the display non-uniformity compensation data corresponding to the first display mode and the second display mode are different, to adapt to their respective pixel driving methods, thereby improving the display effects under different display modes. The display device 000 of the embodiments of the present disclosure includes a display panel 10 and a display driver chip 20 (i.e., DDIC), where the display driver chip 20 is used to cooperate with the complete machine side to complete the switching of the display modes of the display device during the display process. The display driver chip 20 may generally include a storage unit 201 (e.g., Tcon RAM), which is used to store at least the display non-uniformity compensation data.

After the display driver chip 20 receives a mode switching instruction, it will retrieve, from a storage chip such as Flash, the Demura compensation data corresponding to the target display mode to be switched, and load the data into the storage unit 201 of the display driver chip 20. The mode switching is performed after the loading is completed. For example, when it is necessary to switch from the first display mode to the second display mode, after the display driver chip 20 receives the mode switching instruction, it will retrieve the display non-uniformity compensation data corresponding to the second display mode from Flash, load the data into the storage unit 201 of the display driver chip 20, and perform the mode switching after the loading is completed, to display in the second display mode. Finally, when the display panel 10 displays an image, it will perform display non-uniformity compensation for the second display mode according to the display non-uniformity compensation data corresponding to the second display mode stored in the current storage unit 201. Similarly, when it is necessary to switch from the second display mode to the first display mode, after the display driver chip 20 receives the mode switching instruction, it will retrieve the display non-uniformity compensation data corresponding to the first display mode from Flash, load the data into the display driver chip 20, and perform the mode switching after the loading is completed, to display in the first display mode. Finally, when the display panel 10 displays an image, it will perform display non-uniformity compensation for the first display mode according to the display non-uniformity compensation data corresponding to the first display mode stored in the current storage unit 201.

However, it has been found that during the mode switching process, a certain time period is required to retrieve and load the display non-uniformity compensation data corresponding to the target display mode to be switched into the storage unit 201 of the display driver chip 20. Therefore, within the time period from the issuance of the mode switching instruction to the completion of loading, the display panel 10 of the display device 000 remains in the Demura compensation OFF state, that is, the display device does not perform display non-uniformity compensation on the display panel 10 during this time period, which will significantly impair the visual effect of the currently displayed image. Furthermore, if the mount of display non-uniformity compensation data to be retrieved and loaded is large, the loading time will be longer. Thus, the visual defect of display mura will be clearly perceived by users during display mode switching, thereby impairing user experience.

To solve the above problems, an embodiment of the present disclosure provides a display method for a display device. In an example, in either the first display mode or the second display mode, the display driver chip 20 acquires the currently stored display non-uniformity compensation data in the storage unit 201 according to the to-be-displayed image of the display panel 10, so as to perform display non-uniformity compensation on the display image of the display panel 10. In addition, during the mutual switching process between the first display mode and the second display mode, the turn-off time of the display non-uniformity compensation of the display device 000 is less than 40 ms. According to the actual measurement, any visual abnormality that can be perceived and identified by the human eye may be deemed as a result of prolonged mode switching time and the occurrence of display mura, which impairs user experience. Generally, the human eye cannot perceive the flicker if the switching between two images is completed within 40 ms. Therefore, in the embodiments of the present disclosure, by shortening the turn-off time of display non-uniformity compensation during the mutual switching between the first display mode and the second display mode to be less than 40 ms, the switching between the two display modes can be completed within 40 ms, thereby preventing the human eye from perceiving the image flicker, thus weakening the visual effect difference during the mode switching phase to a certain extent, solving the problem of obvious mura state changes in current display products during mode switching, and achieving seamless switching as much as possible and improving user experience.

It should be noted that the embodiments of the present disclosure do not impose any limitation on the structure of the display panel 10, the specific implementation may refer to the structure of an OLED display panel in the related art, which will not be elaborated herein. The display driver chip 20 of the embodiments may be a structure that is bound and electrically connected to the display panel 10, and the components included in the display driver chip 20, such as the storage unit 201, may be integrated into the display driver chip 20. The display driver chip 20 includes but is not limited to the storage unit 201, and may also be integrated with other unit structures capable of driving the display panel 10 to achieve or optimize display effects, which are not limited herein.

In some embodiments, the first display mode of the display device 000 is one of a shared display mode and a privacy protection display mode, and the second display mode is the other one of the shared display mode and the privacy protection display mode. When the display device 000 is applied in the field of in-vehicle displays, the display device 000 includes the privacy protection display mode, which can effectively ensure the driving safety of drivers.

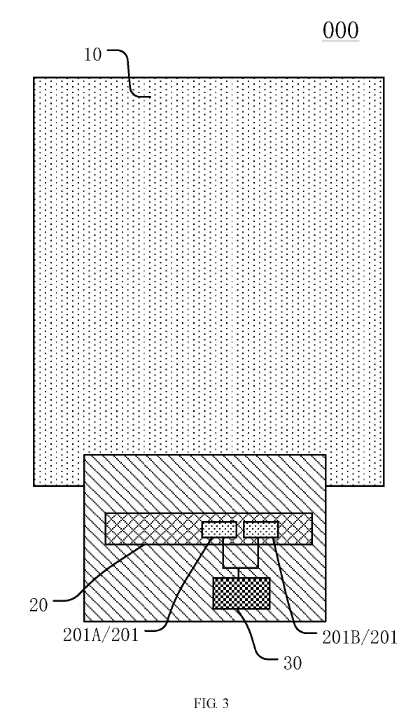

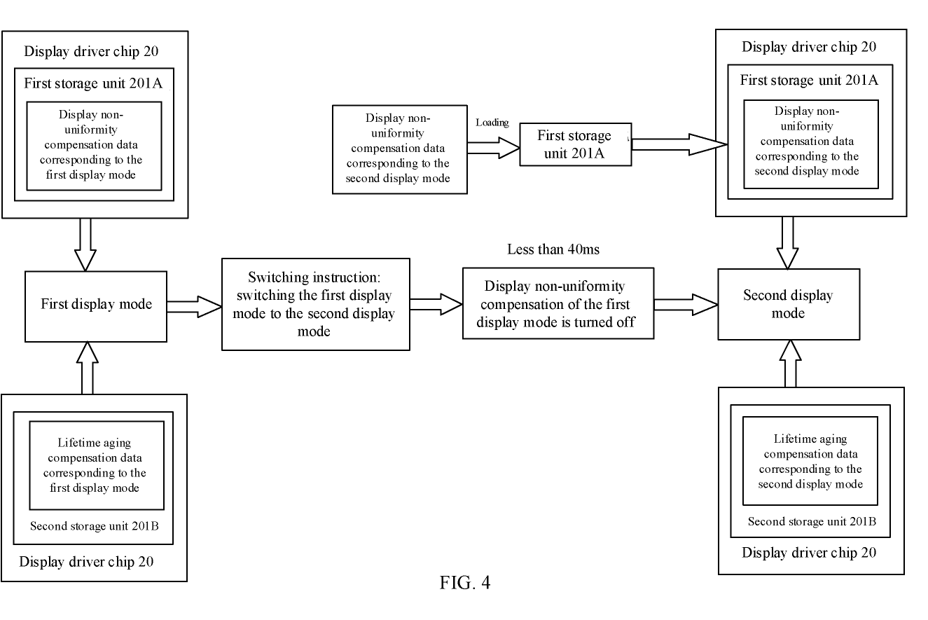

In some embodiments, please refer to FIG. 3 and FIG. 4, where FIG. 3 is another schematic structural diagram of a display device provided in an embodiment of the present disclosure, and FIG. 4 is a flowchart of a display method for the display device in FIG. 3, the storage unit 201 includes a first storage unit 201A and a second storage unit 201B.

In the first display mode, the first storage unit 201A is configured to store the display non-uniformity compensation data corresponding to the first display mode.

In the second display mode, the first storage unit 201A is configured to store display non-uniformity compensation data corresponding to the second display mode.

In the description of the embodiments, the storage unit 201 integrated in the display driver chip 20 may include a first storage unit 201A and second storage unit 201B that are independent of each other, which may not be mutually usable. That is, the display non-uniformity compensation data corresponding to the first display mode and the second display mode are both stored in the first storage unit 201A. In an example, in the first display mode, the first storage unit 201A is used to store the display non-uniformity compensation data corresponding to the first display mode. Before switching from the first display mode to the second display mode, the display non-uniformity compensation data corresponding to the first display mode stored in the first storage unit 201A is released first, then the display non-uniformity compensation data corresponding to the second display mode is loaded and stored to the first storage unit 201A. In other words, in the second display mode, the display non-uniformity compensation data corresponding to the second display mode is still stored in the first storage unit 201A. By configuring the storage unit 201 integrated in the display driver chip 20 to include the first storage unit 201A and second storage unit 201B independent of each other, and the first storage unit 201A and second storage unit 201B may not be mutually usable, the embodiments of the present disclosure can avoid disorder during the data retrieval process of the two storage units and save the time required for data release in the storage units.

In some embodiments, as shown in FIG. 3 and FIG. 4, the second storage unit 201B may be a storage unit of the display device 000 configured to store compensation data required for other compensation functions inherent to the device, such as Lifetime Aging Compensation (LTC) data. Since the organic light-emitting materials in an OLED display panel age with the increase of lighting time, luminance degradation will occur. In addition, these materials of different colors differ in aging rates, color shift (commonly referred to as screen burn-in) may occur. The second storage unit 201B can be designed to store relevant compensation data for mitigating luminance attenuation or color shift caused by the aging of organic light-emitting materials in the display panel; in other words, it is designed to store lifetime aging compensation data. Thus, when the display device 000 needs to perform lifetime aging compensation, the display driver chip 20 can acquire the lifetime aging compensation data stored in the second storage unit 201B according to the to-be-displayed image of the display panel, and perform lifetime aging compensation on the display image of the display panel 10, thereby further alleviating display quality issues caused by the aging of organic light-emitting materials.

In some embodiments, when the first storage unit 201A is configured to store the display non-uniformity compensation data corresponding to the first display mode in the first display mode, and is configured to store the display non-uniformity compensation data corresponding to the second display mode in the second display mode, i.e., the display non-uniformity compensation data are both stored in the first storage unit 201A in the first display mode and the second display mode, the second storage unit 201B then may be configured to store the lifetime aging compensation data corresponding to the first display mode and the lifetime aging compensation data corresponding to the second display mode. As shown in FIG. 4, in the first display mode, the second storage unit 201B is configured to store the lifetime aging compensation data corresponding to the first display mode; in the second display mode, the second storage unit 201B is also configured to store the lifetime aging compensation data corresponding to the second display mode. The first storage unit 201A and the second storage unit 201B in the embodiments have different functions and store different types of data, and thus may not be mutually usable. This prevents disorder during the data retrieval process of the two storage units and saves the time required for data release in the storage units.

The second storage unit 201B in the embodiments is configured to store the lifetime aging compensation data corresponding to the first display mode and the lifetime aging compensation data corresponding to the second display mode. In an example, in the first display mode, the second storage unit 201B is configured to store the lifetime aging compensation data corresponding to the first display mode; and in the second display mode, the second storage unit 201B is also configured to store the lifetime aging compensation data corresponding to the second display mode. Then, when the display device 000 performs display image compensation, at least two types of compensation (lifetime aging compensation and display non-uniformity compensation) are required for each display mode. For example, in the first display mode, the display driver chip 20 acquires the display non-uniformity compensation data corresponding to the first display mode stored in the first storage unit 201A according to the to-be-displayed image of the display panel, so as to perform display non-uniformity compensation on the display image of the display panel 10, and the display driver chip 20 acquires the lifetime aging compensation data corresponding to the first display mode stored in the second storage unit 201B according to the to-be-displayed image of the display panel 10, so as to perform lifetime aging compensation on the display image of the display panel 10; in the second display mode, the display driver chip 20 acquires the display non-uniformity compensation data corresponding to the second display mode reloaded and stored in the first storage unit 201A according to the to-be-displayed image of the display panel, so as to perform display non-uniformity compensation on the display image of the display panel 10, and the display driver chip 20 acquires the lifetime aging compensation data corresponding to the second display mode reloaded and stored in the second storage unit 201B according to the to-be-displayed image of the display panel 10, so as to perform lifetime aging compensation on the display image of the display panel 10. When the display device 000 of the embodiments performs displaying, it can not only correct mura defects caused by non-uniform screen brightness and chromaticity through display non-uniformity compensation to improve image quality uniformity, but also alleviate luminance attenuation or color shift caused by the aging of organic light-emitting materials in the panel through lifetime aging compensation. This achieves a goal of improving display quality by means of at least two different image compensation methods.

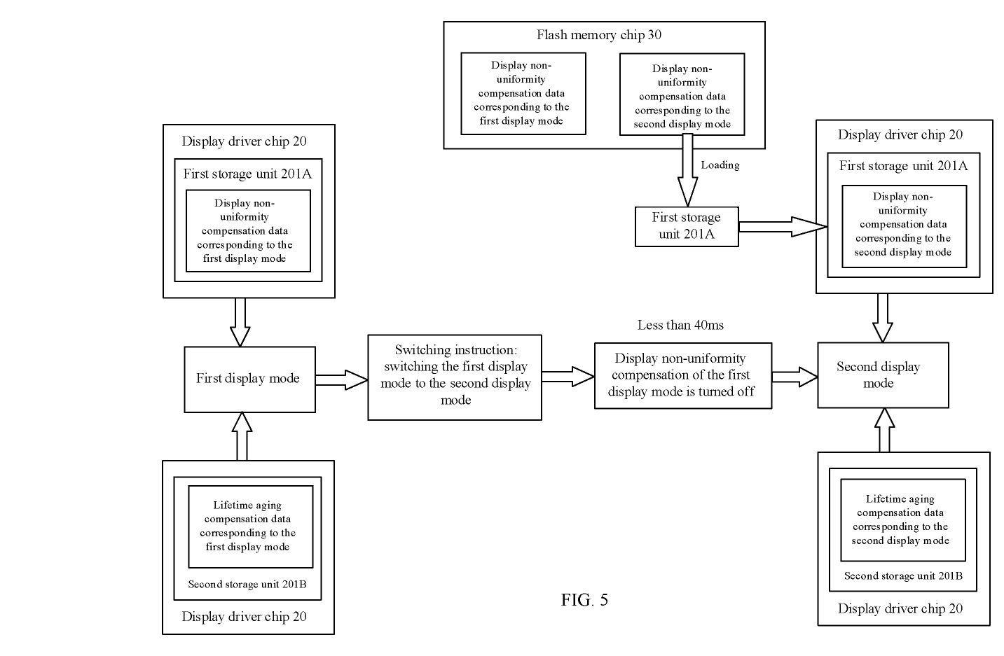

In some embodiments, please refer to FIG. 3 and FIG. 5, where FIG. 5 is another flowchart of a display method for the display device in FIG. 3, the display device 000 further includes a flash memory chip 30. The flash memory chip 30 stores the display non-uniformity compensation data corresponding to the first display mode and the display non-uniformity compensation data corresponding to the second display mode.

The process of switching from the first display mode to the second display mode includes: obtaining a mode switching instruction; turning off the display non-uniformity compensation of the first display mode and releasing the display non-uniformity compensation data corresponding to the first display mode stored in the first storage unit 201A; loading, by the flash memory chip 30, the stored display non-uniformity compensation data corresponding to the second display mode into the first storage unit 201A; turning on the display non-uniformity compensation of the second display mode, and acquiring, by the display driver chip 20, the display non-uniformity compensation data corresponding to the second display mode stored in the first storage unit 201A according to the to-be-displayed image of the display panel, so as to perform display non-uniformity compensation on the display image of the display panel 10.

In the description of the embodiments, the display non-uniformity compensation data corresponding to the first display mode and the display non-uniformity compensation data corresponding to the second display mode can both be pre-stored in the flash memory chip 30 (i.e., Flash chip) included in the display device 000. Storing both the display non-uniformity compensation data corresponding to the first display mode and the display non-uniformity compensation data corresponding to the second display mode in a single flash memory chip 30 helps reduce the overall manufacturing cost of the display device 000. When the display mode of the display device 000 is switched, for example, switched from the first display mode to the second display mode, after the display driver chip 20 obtains the mode switching instruction, the display non-uniformity compensation of the first display mode is turned off, and the display non-uniformity compensation data corresponding to the first display mode originally stored in the first storage unit 201A is released simultaneously. The data release process is extremely fast and almost negligible. Subsequently, the flash memory chip 30 loads the pre-stored display non-uniformity compensation data corresponding to the second display mode into the first storage unit 201A with released storage space. At this time, the display non-uniformity compensation of the second display mode can be turned on immediately. The display driver chip 20 acquires the display non-uniformity compensation data corresponding to the second display mode stored in the first storage unit 201A according to the to-be-displayed image of the display panel, so as to perform display non-uniformity compensation on the display image of the display panel 10. It can be seen that the turn-off time of the display non-uniformity compensation of the display device 000 only includes the time required for the flash memory chip 30 to load the pre-stored display non-uniformity compensation data corresponding to the second display mode into the first storage unit 201A with released storage space. This time duration can be set to be less than 40 ms, which can weaken the visual effect difference during the mode switching phase to a certain extent, achieve seamless switching where the human eye cannot detect any image abnormality, and improve user experience.

It should be noted that FIG. 3 in the embodiments only takes the flash memory chip 30 disposed externally to the display driver chip 20 as an example for illustration. In some other embodiments, the flash memory chip 30 may also be integrated into the display driver chip 20 to improve the chip integration level of the display device, which facilitates the development of display devices in terms of being free of external storage. The specific configuration can be selected according to actual requirements.

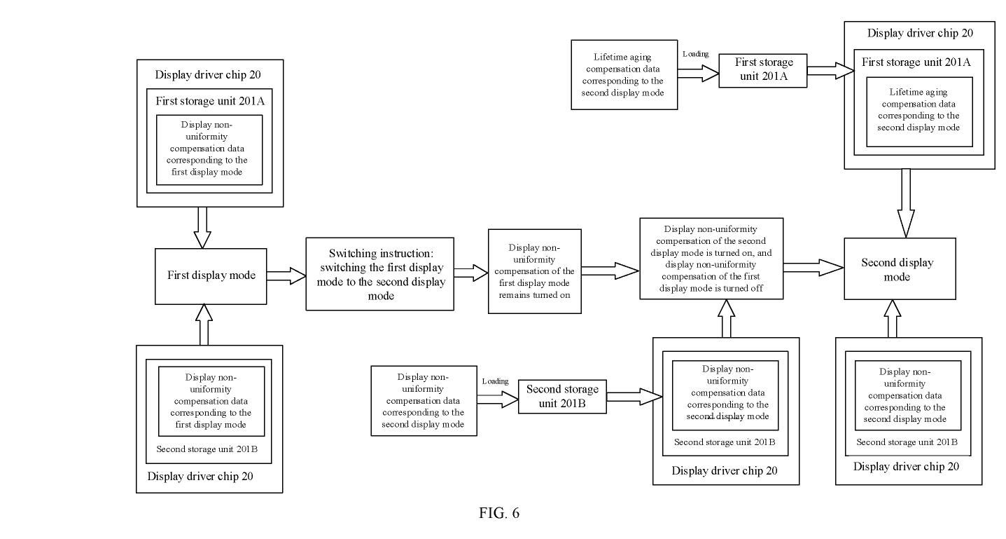

In some embodiments, please refer to FIG. 3 and FIG. 6, where FIG. 6 is another flowchart of a display method for the display device in FIG. 3, the storage unit 201 includes a first storage unit 201A and a second storage unit 201B.

In the first display mode, the first storage unit 201A is configured to store the display non-uniformity compensation data corresponding to the first display mode.

In the second display mode, the second storage unit 201B is configured to store the display non-uniformity compensation data corresponding to the second display mode.

In the description of the embodiments, the storage unit 201 integrated in the display driver chip 20 may include a first storage unit 201A and a second storage unit 201B independent of each other, and the first storage unit 201A and the second storage unit 201B may be mutually usable. In an example, in the first display mode, the first storage unit 201A is used to store the display non-uniformity compensation data corresponding to the first display mode, while in the second display mode, the second storage unit 201B is used to store the display non-uniformity compensation data corresponding to the second display mode. Before switching from the first display mode to the second display mode, it is not necessary to release the display non-uniformity compensation data corresponding to the first display mode stored in the first storage unit 201A, and the display non-uniformity compensation of the display device may remain turned on based on the display non-uniformity compensation data corresponding to the first display mode stored in the first storage unit 201A (as shown in FIG. 6). After the second storage unit 201B completes loading and storing the display non-uniformity compensation data corresponding to the second display mode, the display non-uniformity compensation of the display device may be turned on based on the display non-uniformity compensation data corresponding to the second display mode stored in the second storage unit 201B. Meanwhile, the display non-uniformity compensation of the first display mode may be turned off. This enables seamless switching between the display non-uniformity compensation of the first display mode and the display non-uniformity compensation of the second display mode. During the mutual switching process between the first display mode and the second display mode in the embodiments, the turn-off time of the display non-uniformity compensation of the display device is 0. That is, during the mutual switching between the first display mode and the second display mode, the display non-uniformity compensation of the display device 000 remains in the ON state all the time. This can weaken the visual effect difference during the mode switching phase, solve the problem of obvious mura state changes in current display products during mode switching, maximize seamless switching, and further improve user experience.

In some embodiments, since the organic light-emitting materials in an OLED display panel age with the increase of lighting time, luminance degradation will occur. In addition, these materials of different colors differ in aging rates, color shift (commonly referred to as screen burn-in) may occur. Therefore, when the display device displays an image, the storage unit 201 also needs to store lifetime aging compensation data for mitigating luminance attenuation or color shift caused by the aging of organic light-emitting materials in the display panel 10, so that when the display device 000 needs to perform lifetime aging compensation, the display driver chip 20 can acquire the lifetime aging compensation data stored in the storage unit 201 according to the to-be-displayed image of the display panel, so as to perform lifetime aging compensation on the display image of the display panel 10, thereby further alleviating display quality issues caused by the aging of organic light-emitting materials.

In some embodiments, the storage unit 201 in the embodiments includes a first storage unit 201A and second storage unit 201B independent of each other, which may be mutually usable. This can be understood as follows: in the first display mode, the first storage unit 201A is configured to store the display non-uniformity compensation data corresponding to the first display mode, and the second storage unit 201B is configured to store the lifetime aging compensation data corresponding to the first display mode; and in the second display mode, the second storage unit 201B is configured to store the display non-uniformity compensation data corresponding to the second display mode, and the first storage unit 201A is configured to store the lifetime aging compensation data corresponding to the second display mode.

In an example, as shown in FIG. 6, in the first display mode, the first storage unit 201A is configured to store the display non-uniformity compensation data corresponding to the first display mode, and the second storage unit 201B is configured to store the lifetime aging compensation data corresponding to the first display mode. The display driver chip 20 acquires the display non-uniformity compensation data corresponding to the first display mode stored in the first storage unit 201A according to the to-be-displayed image of the display panel, so as to perform display non-uniformity compensation on the display image of the display panel 10; meanwhile, the display driver chip 20 acquires the lifetime aging compensation data corresponding to the first display mode stored in the second storage unit 201B according to the to-be-displayed image of the display panel, so as to perform lifetime aging compensation on the display image of the display panel 10. When the display mode of the display device 000 is switched, for example, switched from the first display mode to the second display mode, after the display driver chip 20 obtains the mode switching instruction, the first storage unit 201A does not need to release storage space for loading and storing the display non-uniformity compensation data corresponding to the second display mode. Therefore, the display non-uniformity compensation of the first display mode may remain turned on, while the lifetime aging compensation data corresponding to the first display mode originally stored in the second storage unit 201B is released simultaneously. The data release process is extremely fast and almost negligible. Subsequently, after the display non-uniformity compensation data corresponding to the second display mode is loaded into the second storage unit 201B with released storage space, the display non-uniformity compensation of the second display mode can be turned on immediately, and the display non-uniformity compensation of the first display mode can be turned off at this time. The display non-uniformity compensation of the second display mode achieves seamless switching with the display non-uniformity compensation of the first display mode. The display driver chip 20 continues to acquire the display non-uniformity compensation data corresponding to the second display mode stored in the second storage unit 201B according to the to-be-displayed image of the display panel, so as to perform display non-uniformity compensation on the display image of the display panel 10. In addition, after the display non-uniformity compensation of the second display mode is turned on, the space of the first storage unit 201A can be released for loading and storing the lifetime aging compensation data corresponding to the second display mode. That is, in the second display mode, the first storage unit 201A is configured to store the lifetime aging compensation data corresponding to the second display mode, and the second storage unit 201B is configured to store the display non-uniformity compensation data corresponding to the second display mode. The display driver chip 20 acquires the display non-uniformity compensation data corresponding to the second display mode stored in the second storage unit 201B according to the to-be-displayed image of the display panel, so as to perform display non-uniformity compensation on the display image of the display panel 10; meanwhile, the display driver chip 20 acquires the lifetime aging compensation data corresponding to the second display mode stored in the first storage unit 201A according to the to-be-displayed image of the display panel 10, so as to perform lifetime aging compensation on the display image of the display panel 10. When the display device 000 of the embodiments performs displaying, it can not only correct mura defects caused by non-uniform screen brightness and chromaticity through display non-uniformity compensation to improve image quality uniformity, but also alleviate luminance attenuation or color shift caused by the aging of organic light-emitting materials in the panel through lifetime aging compensation. This achieves a goal of improving display quality by means of at least two different image compensation methods.

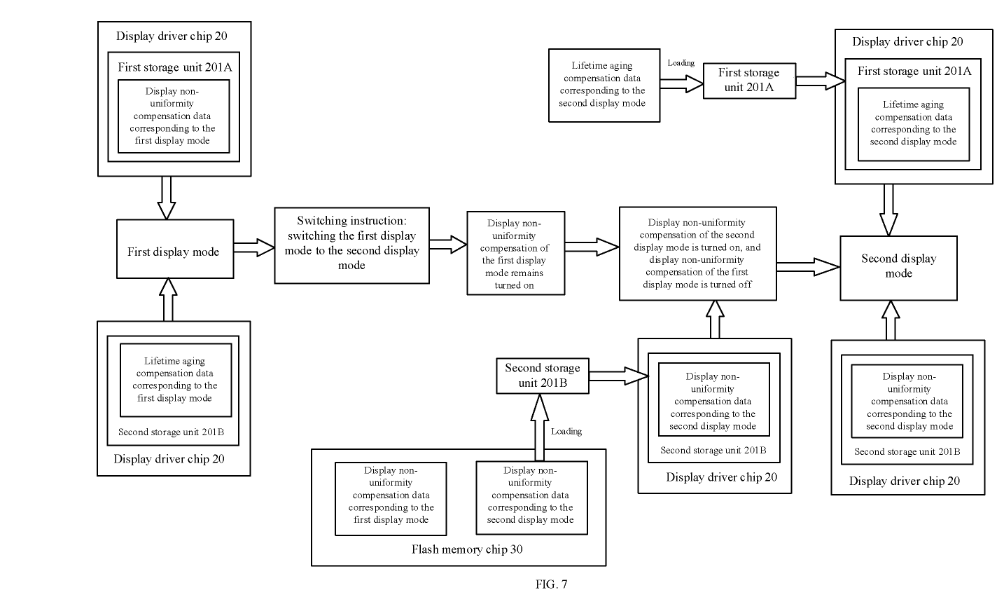

In some embodiments, please refer to FIG. 3 and FIG. 7, where FIG. 7 is another flowchart of a display method for the display device in FIG. 3, the display device further includes a flash memory chip 30. The flash memory chip 30 stores the display non-uniformity compensation data corresponding to the first display mode and the display non-uniformity compensation data corresponding to the second display mode.

The process of switching from the first display mode to the second display mode includes: obtaining a mode switching instruction; keeping the display non-uniformity compensation of the first display mode turned on; loading, by the flash memory chip 30, the stored display non-uniformity compensation data corresponding to the second display mode into the second storage unit 201B; turning on the display non-uniformity compensation of the second display mode, and acquiring, by the display driver chip 20, the display non-uniformity compensation data corresponding to the second display mode stored in the second storage unit 201B according to the to-be-displayed image of the display panel, so as to perform display non-uniformity compensation on the display image of the display panel 10.

In the description of the embodiments, the display non-uniformity compensation data corresponding to the first display mode and the display non-uniformity compensation data corresponding to the second display mode can both be pre-stored in the flash memory chip 30 (i.e., Flash chip) included in the display device 000. Storing both the display non-uniformity compensation data corresponding to the first display mode and the display non-uniformity compensation data corresponding to the second display mode in a single flash memory chip 30 helps reduce the overall manufacturing cost of the display device 000. When the display mode of the display device 000 is switched, for example, switched from the first display mode to the second display mode, after the display driver chip 20 obtains the mode switching instruction, the display non-uniformity compensation of the first display mode remains turned on, while the lifetime aging compensation data corresponding to the first display mode originally stored in the second storage unit 201B is released simultaneously. The data release process is extremely fast and almost negligible. Subsequently, the flash memory chip 30 loads the pre-stored display non-uniformity compensation data corresponding to the second display mode into the second storage unit 201B with released storage space. At this time, the display non-uniformity compensation of the second display mode can be turned on immediately, and the display non-uniformity compensation of the first display mode can be turned off immediately. The display non-uniformity compensation of the second display mode achieves seamless switching with the display non-uniformity compensation of the first display mode. The display driver chip 20 acquires the display non-uniformity compensation data corresponding to the second display mode stored in the second storage unit 201B according to the to-be-displayed image of the display panel, so as to perform display non-uniformity compensation on the display image of the display panel 10. After the display non-uniformity compensation of the second display mode is turned on, the space of the first storage unit 201A can be released, and the flash memory chip 30 loads the pre-stored lifetime aging compensation data corresponding to the second display mode into the first storage unit 201A with released storage space. That is, in the second display mode, the first storage unit 201A is configured to store the lifetime aging compensation data corresponding to the second display mode, and the second storage unit 201B is configured to store the display non-uniformity compensation data corresponding to the second display mode. The display driver chip 20 acquires the display non-uniformity compensation data corresponding to the second display mode stored in the second storage unit 201B according to the to-be-displayed image of the display panel, so as to perform display non-uniformity compensation on the display image of the display panel 10; meanwhile, the display driver chip 20 acquires the lifetime aging compensation data corresponding to the second display mode stored in the first storage unit 201A according to the to-be-displayed image of the display panel, so as to perform lifetime aging compensation on the display image of the display panel 10.

It can be seen that in the embodiments, during the mode switching process, the turn-off time of the display non-uniformity compensation of the display device 000 is 0. That is, during the mode switching process, the display non-uniformity compensation remains turned on continuously, which can more effectively weaken the visual effect difference during the mode switching phase, maximize seamless switching where the human eye cannot detect any image abnormality, and further improve user experience.

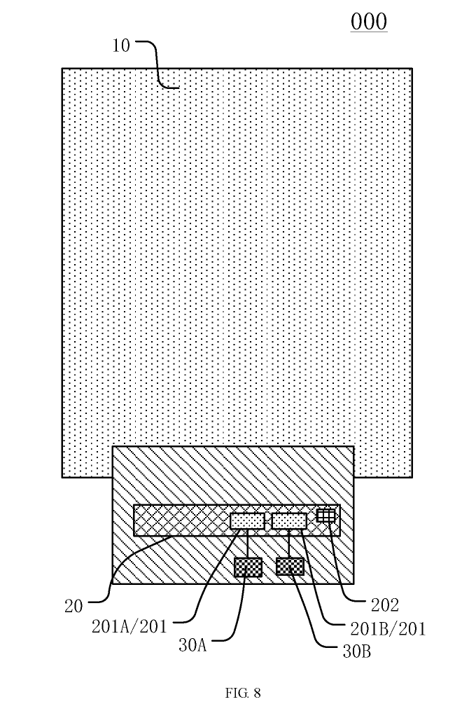

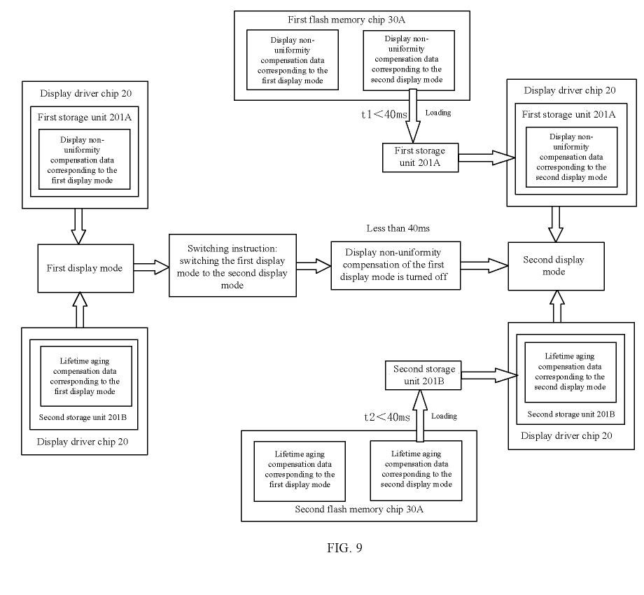

In some embodiments, please refer to FIG. 8 and FIG. 9, where FIG. 8 is another schematic structural diagram of a display device provided in an embodiment of the present disclosure, and FIG. 9 is a flowchart of a display method for the display device in FIG. 8, the display device 000 further includes a first flash memory chip 30A and a second flash memory chip 30B.

The first flash memory chip 30A stores the display non-uniformity compensation data corresponding to the first display mode and the display non-uniformity compensation data corresponding to the second display mode.

The second flash memory chip 30B stores the lifetime aging compensation data corresponding to the first display mode and the lifetime aging compensation data corresponding to the second display mode.

The storage unit 201 includes a first storage unit 201A and a second storage unit 201B.

During the process of switching from the first display mode to the second display mode, the first flash memory chip 30A loads the stored display non-uniformity compensation data corresponding to the second display mode into the first storage unit 201A; and the second flash memory chip 30B loads the stored lifetime aging compensation data corresponding to the second display mode into the second storage unit 201B.

In some embodiments, the loading time for the first flash memory chip 30A to load the stored display non-uniformity compensation data corresponding to the second display mode into the first storage unit 201A is defined as t1; and the loading time for the second flash memory chip 30B to load the stored lifetime aging compensation data corresponding to the second display mode into the second storage unit 201B is defined as t2, where t1 < 40 ms, and t2 < 40 ms.

In the description of the embodiments, the display non-uniformity compensation data corresponding to the first display mode and the display non-uniformity compensation data corresponding to the second display mode can both be pre-stored in a single first flash memory chip 30A included in the display device 000, and the lifetime aging compensation data corresponding to the first display mode and the lifetime aging compensation data corresponding to the second display mode can both be pre-stored in another second flash memory chip 30B included in the display device 000. Storing different types of compensation data in two separate flash memory chips helps shorten the time required for data retrieval and loading. In an implementation, the display device 000 can be developed with dual Flash interfaces, with two flash memory chips externally mounted, namely, the first flash memory chip 30A and the second flash memory chip 30B. The display non-uniformity compensation data corresponding to the first display mode, the display non-uniformity compensation data corresponding to the second display mode, the lifetime aging compensation data corresponding to the first display mode, and the lifetime aging compensation data corresponding to the second display mode are stored in the first flash memory chip 30A and the second flash memory chip 30B respectively. That is, the display non-uniformity compensation data corresponding to the first display mode and the display non-uniformity compensation data corresponding to the second display mode can both be pre-stored in the first flash memory chip 30A of the display device 000, and the lifetime aging compensation data corresponding to the first display mode and the lifetime aging compensation data corresponding to the second display mode can both be pre-stored in the second flash memory chip 30B of the display device 000. During display mode switching, the display non-uniformity compensation data and lifetime aging compensation data corresponding to the newly switched display mode can be loaded simultaneously, which helps reduce the switching duration. For example, when switching from the first display mode to the second display mode, the first flash memory chip 30A loads the stored display non-uniformity compensation data corresponding to the second display mode into the first storage unit 201A, with the loading time t1 controlled to be less than 40 ms; and the second flash memory chip 30B loads the stored lifetime aging compensation data corresponding to the second display mode into the second storage unit 201B, with the loading time t2 controlled to be less than 40 ms. This ensures that during the mutual switching between the first display mode and the second display mode, the turn-off time of the display non-uniformity compensation of the display device 000 is less than 40 ms, enabling the switching between the two display modes to be completed within 40 ms. As a result, the human eye cannot perceive the flicker, the visual effect difference during the mode switching phase can be weakened to a certain extent, the problem of obvious mura state changes in current display products during mode switching is solved, seamless switching is achieved as much as possible, and user experience is improved.

It is understandable that the embodiments adopt a solution of developing dual Flash interfaces with two externally mounted flash memory chips (i.e., the first flash memory chip 30A and the second flash memory chip 30B). By storing different types of compensation data in two flash memory chips, during mode switching, the two flash memory chips simultaneously load the display non-uniformity compensation data and lifetime aging compensation data corresponding to the new mode into the first storage unit 201A and the second storage unit 201B respectively. Moreover, with the improvement of data compression ratio and data loading rate, the embodiments can control the loading time t1 for the first flash memory chip 30A to load the stored display non-uniformity compensation data corresponding to the second display mode into the first storage unit 201A to be less than 40 ms; and the loading time t2 for the second flash memory chip 30B to load the stored lifetime aging compensation data corresponding to the second display mode into the second storage unit 201B can also be controlled to be less than 40 ms. This ensures that during the mutual switching between the first display mode and the second display mode, the turn-off time of the display non-uniformity compensation of the display device 000 is less than 40 ms, thereby effectively weakening the visual effect difference during the mode switching phase, achieving seamless switching as much as possible, and improving user experience.

In some embodiments, the display method for the display device 000 includes: as shown in FIG. 9, before switching from the first display mode to the second display mode (that is, in the first display mode): acquiring, by the display driver chip 20, the display non-uniformity compensation data corresponding to the first display mode stored in the first storage unit 201A according to the to-be-displayed image of the display panel 10, to perform display non-uniformity compensation on the display image of the display panel 10; and acquiring, by the display driver chip 20, the lifetime aging compensation data corresponding to the first display mode stored in the second storage unit 201B according to the to-be-displayed image of the display panel 10, to perform lifetime aging compensation on the display image of the display panel 10.

The process of switching from the first display mode to the second display mode includes: obtaining a mode switching instruction; turning off the display non-uniformity compensation of the first display mode and releasing the display non-uniformity compensation data corresponding to the first display mode stored in the first storage unit 201A, the data release process being extremely fast and almost negligible; turning off the lifetime aging compensation of the first display mode and releasing the lifetime aging compensation data corresponding to the first display mode stored in the second storage unit 201B, the data release process being extremely fast and almost negligible; loading, by the first flash memory chip 30A, the stored display non-uniformity compensation data corresponding to the second display mode into the first storage unit 201A, and loading, by the second flash memory chip 30B, the stored lifetime aging compensation data corresponding to the second display mode into the second storage unit 201B; turning on the display non-uniformity compensation of the second display mode, acquiring, by the display driver chip 20, the display non-uniformity compensation data corresponding to the second display mode stored in the first storage unit 201A according to the to-be-displayed image of the display panel 10, to perform display non-uniformity compensation on the display image of the display panel 10; and turning on the lifetime aging compensation of the second display mode, acquiring, by the display driver chip 20, the lifetime aging compensation data corresponding to the second display mode stored in the second storage unit 201B according to the to-be-displayed image of the display panel 10, to perform lifetime aging compensation on the display image of the display panel 10; and completing the switching from the first display mode to the second display mode.

The display method for the display device provided in the embodiment ensures that during the mutual switching between the first display mode and the second display mode, the turn-off time of the display non-uniformity compensation of the display device 000 is less than 40 ms. This helps prevent the human eye from perceiving the flicker, weakens the visual effect difference during the mode switching phase to a certain extent, solves the problem of obvious mura state changes in current display products during mode switching, achieves seamless switching as much as possible, and improves user experience.

In some embodiments, as shown in FIG. 8, the display driver chip 20 may further include a timing control module 202. The timing control module 202 controls the first flash memory chip 30A to load the stored display non-uniformity compensation data corresponding to the second display mode into the first storage unit 201A, and controls the second flash memory chip 30B to load the stored lifetime aging compensation data corresponding to the second display mode into the second storage unit 201B. Through the configuration of the timing control module 202, it is possible to predict in advance the current display mode and which storage unit requires what data, thereby enabling the retrieval of different compensation data. For example, if the timing control module 202 determines that the current display mode of the display device 000 is the second display mode according to the current driving method, the timing control module 202 controls the operation of the first flash memory chip 30A and the second flash memory chip 30B in such a manner that the first flash memory chip 30A loads the stored display non-uniformity compensation data corresponding to the second display mode into the first storage unit 201A, and the second flash memory chip 30B loads the stored lifetime aging compensation data corresponding to the second display mode into the second storage unit 201B, thereby realizing the switching from the first display mode to the second display mode. Similarly, if the timing control module 202 determines that the current display mode of the display device 000 is the first display mode according to the current driving method, the timing control module 202 controls the operation of the first flash memory chip 30A and the second flash memory chip 30B in such a manner that the first flash memory chip 30A loads the stored display non-uniformity compensation data corresponding to the first display mode into the first storage unit 201A, and the second flash memory chip 30B loads the stored lifetime aging compensation data corresponding to the first display mode into the second storage unit 201B, thereby realizing the switching from the second display mode to the first display mode.

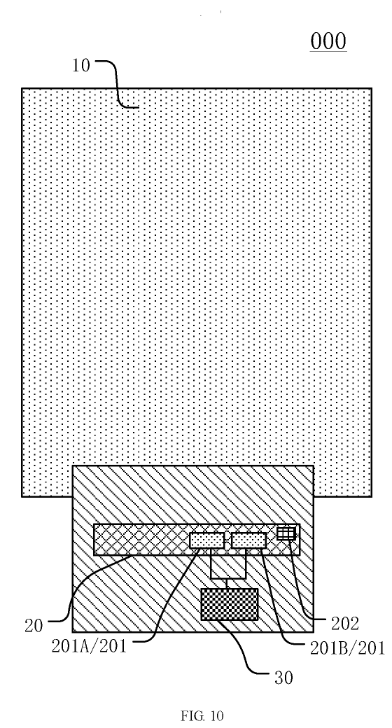

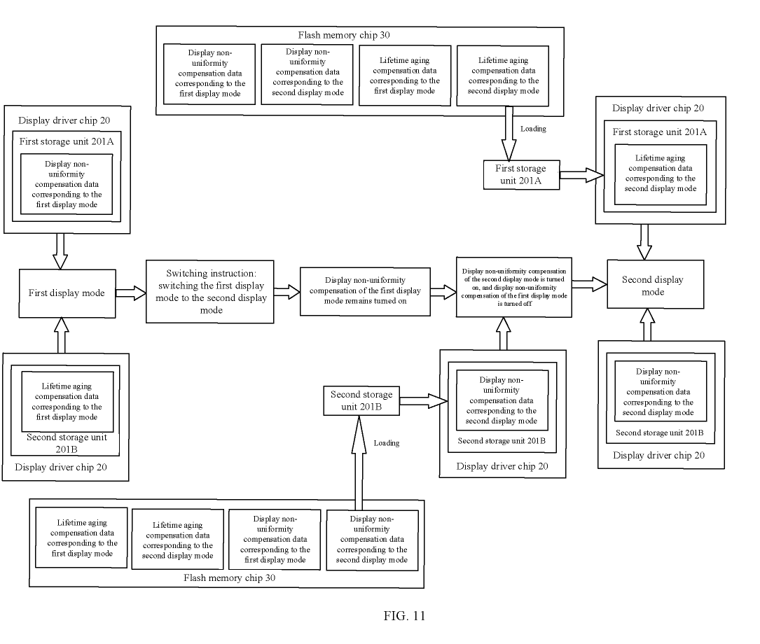

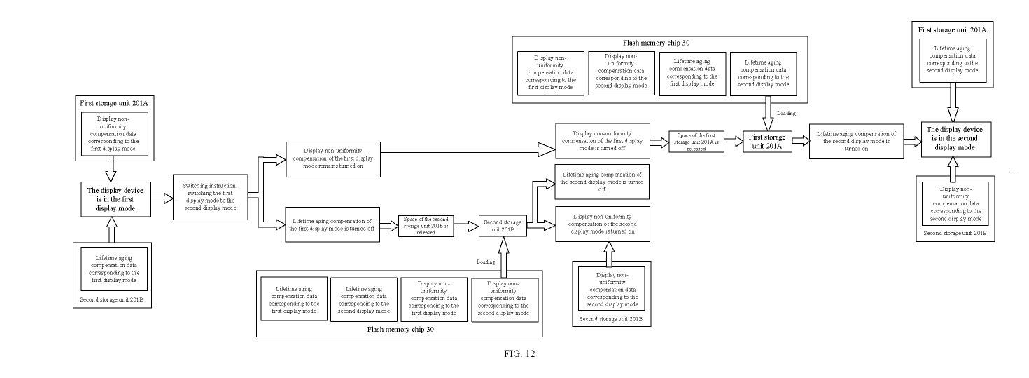

In some embodiments, please refer to FIG. 10, FIG. 11 and FIG. 12, where FIG. 10 is another schematic structural diagram of a display device provided in an embodiment of the present disclosure, FIG. 11 is a flowchart of a display method for the display device in FIG. 10, and FIG. 12 is a schematic diagram of a flow of the display method in FIG. 11, the display device 000 further includes a flash memory chip 30, where the flash memory chip 30 stores the display non-uniformity compensation data corresponding to the first display mode, the display non-uniformity compensation data corresponding to the second display mode, the lifetime aging compensation data corresponding to the first display mode, and the lifetime aging compensation data corresponding to the second display mode.

The storage unit 201 includes a first storage unit 201A and a second storage unit 201B.

As shown in FIG. 11 and FIG. 12, the display method for the display device 000 includes: before switching from the first display mode to the second display mode (that is, in the first display mode): acquiring, by the display driver chip 20, the display non-uniformity compensation data corresponding to the first display mode stored in the first storage unit 201A according to the to-be-displayed image of the display panel 10, to perform display non-uniformity compensation on the display image of the display panel 10; acquiring, by the display driver chip 20, the lifetime aging compensation data corresponding to the first display mode stored in the second storage unit 201B according to the to-be-displayed image of the display panel 10, to perform lifetime aging compensation on the display image of the display panel 10.

Then, the process of switching from the first display mode to the second display mode includes: obtaining a mode switching instruction; keeping the display non-uniformity compensation of the first display mode turned on, without releasing the display non-uniformity compensation data corresponding to the first display mode stored in the first storage unit 201A; turning off the lifetime aging compensation of the first display mode, with releasing the lifetime aging compensation data corresponding to the first display mode stored in the second storage unit 201B, the operation of releasing the lifetime aging compensation data being extremely fast and negligible; loading, by the flash memory chip 30, the stored display non-uniformity compensation data corresponding to the second display mode into the second storage unit 201B; turning on the display non-uniformity compensation of the second display mode, and acquiring, by the display driver chip 20, the display non-uniformity compensation data corresponding to the second display mode stored in the second storage unit 201B according to the to-be-displayed image of the display panel 10, to perform display non-uniformity compensation on the display image of the display panel 10, meaning that the display device enters the second display mode; while the display non-uniformity compensation of the second display mode is turned on, the display non-uniformity compensation of the first display mode being turned off immediately, and the display non-uniformity compensation data corresponding to the first display mode stored in the first storage unit 201A being released, the operation of releasing the display non-uniformity compensation data being extremely fast and negligible, in addition, turning off the lifetime aging compensation of the first display mode having a smaller impact on the visual effect of the display device compared with turning off display non-uniformity compensation; loading, by the flash memory chip 30, the stored lifetime aging compensation data corresponding to the second display mode into the first storage unit 201A; and turning on the lifetime aging compensation of the second display mode, and acquiring, by the display driver chip 20, the lifetime aging compensation data corresponding to the second display mode stored in the first storage unit 201A according to the to-be-displayed image of the display panel 10, to perform lifetime aging compensation on the display image of the display panel 10; and completing the switching from the first display mode to the second display mode.

The display method for the display device provided in the embodiments ensures that during the mutual switching between the first display mode and the second display mode, the display non-uniformity compensation of the display device 000 remains continuously turned on. That is, during the mutual switching between the first display mode and the second display mode, the turn-off time of the display non-uniformity compensation of the display device is 0. This helps prevent the human eye from perceiving the flicker, minimizes the visual effect difference during the mode switching phase, solves the problem of obvious mura state changes in current display products during mode switching, maximizes seamless switching, and effectively improves user experience.

In some embodiments, as shown in FIG. 10, the display driver chip 20 may further include a timing control module 202. The timing control module 202 controls the flash memory chip 30 to load the stored display non-uniformity compensation data corresponding to the second display mode into the second storage unit 201B after the lifetime aging compensation of the first display mode is turned off; the timing control module 202 controls the flash memory chip 30 to load the stored lifetime aging compensation data corresponding to the second display mode into the first storage unit 201A after the display non-uniformity compensation of the first display mode is turned off.

Through the configuration of the timing control module 202, it is possible to predict in advance the current display mode and which storage unit requires what data, thereby enabling the retrieval of different compensation data. For example, if the timing control module 202 determines that the current display mode of the display device 000 is the second display mode according to the current driving method, the timing control module 202 controls the operation of the flash memory chip 30, in such a manner that after the lifetime aging compensation of the first display mode is turned off, i.e., after the second storage unit 201B releases space, the flash memory chip 30 loads the stored display non-uniformity compensation data corresponding to the second display mode into the second storage unit 201B; and after the display non-uniformity compensation of the first display mode is turned off, i.e., after the first storage unit 201A releases space, the flash memory chip 30 loads the stored lifetime aging compensation data corresponding to the second display mode into the first storage unit 201A, thereby realizing the switching from the first display mode to the second display mode. Similarly, if the timing control module 202 determines that the current display mode of the display device 000 is the first display mode according to the current driving method, the timing control module 202 controls the operation of the flash memory chip 30, in such a manner that after the lifetime aging compensation of the second display mode is turned off, i.e., after the first storage unit 201A releases space, the flash memory chip 30 loads the stored display non-uniformity compensation data corresponding to the first display mode into the first storage unit 201A; and after the display non-uniformity compensation of the second display mode is turned off, i.e., after the second storage unit 201B releases space, the flash memory chip 30 loads the stored lifetime aging compensation data corresponding to the first display mode into the second storage unit 201B; and completing the switching from the second display mode to the first display mode.

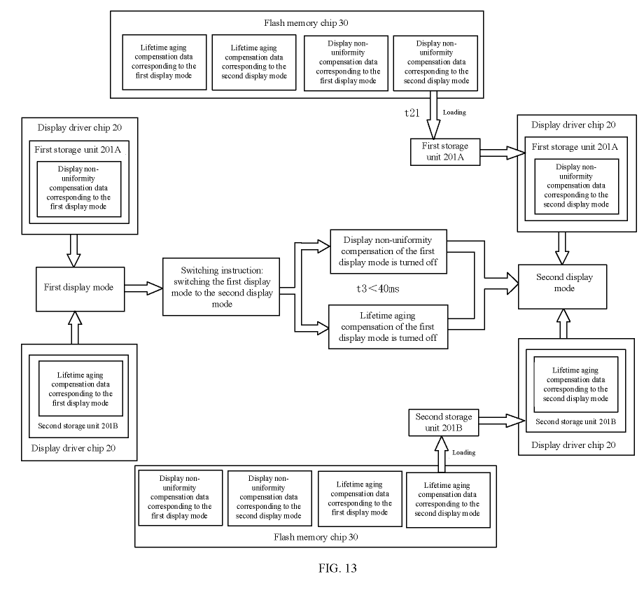

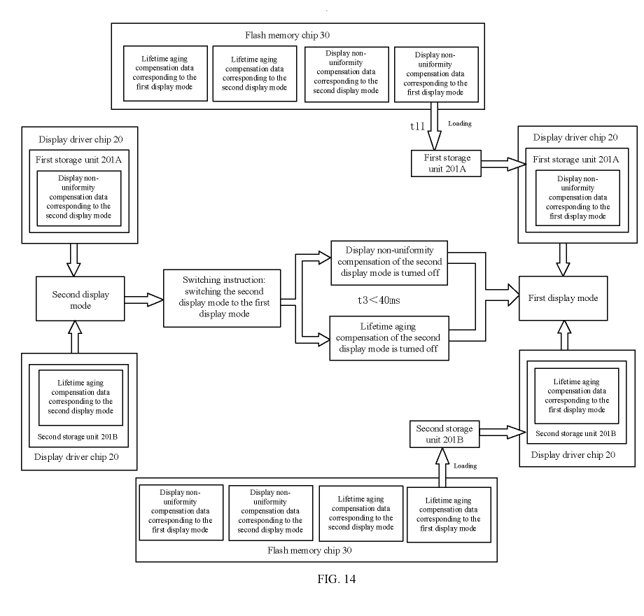

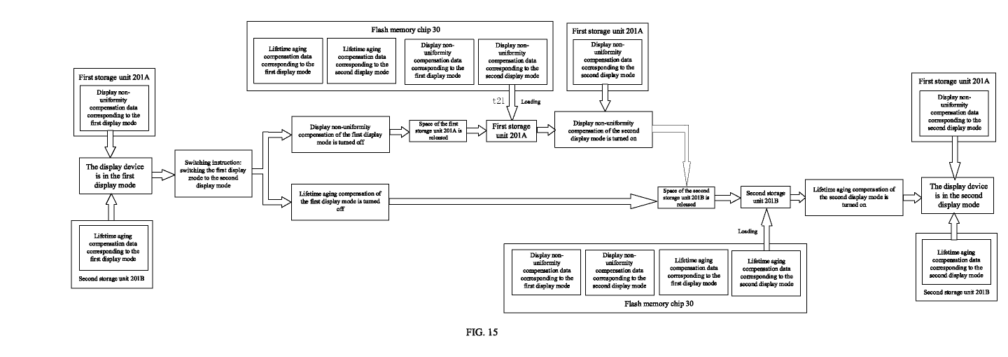

In some embodiments, please refer to FIG. 10, FIG. 13, FIG. 14 and FIG. 15, where FIG. 13 is a flowchart of switching the first display mode to the second display mode in the display method for the display device shown in FIG. 10, FIG. 14 is a flowchart of switching the second display mode to the first display mode in the display method for the display device shown in FIG. 10, and FIG. 15 is a schematic diagram of a flow of the display method shown in FIG. 13, the display device 000 further includes a flash memory chip 30, where the flash memory chip 30 stores the display non-uniformity compensation data corresponding to the first display mode, the display non-uniformity compensation data corresponding to the second display mode, the lifetime aging compensation data corresponding to the first display mode, and the lifetime aging compensation data corresponding to the second display mode.

The storage unit 201 includes a first storage unit 201A and a second storage unit 201B.

The loading time for the flash memory chip 30 to load the stored display non-uniformity compensation data corresponding to the first display mode into the first storage unit 201A is defined as t11, as shown in FIG. 14; the loading time for the flash memory chip 30 to load the stored display non-uniformity compensation data corresponding to the second display mode into the first storage unit 201A is defined as t21, as shown in FIG. 14; during the mutual switching process between the first display mode and the second display mode, the turn-off time of the display non-uniformity compensation of the display device is defined as t3, where t3 ≤ t11, or t3 ≤ t21.

In the description of the embodiments, in a display method for the display device, it is also possible to control the turn-off time of the display non-uniformity compensation of the first display mode (i.e., the turn-off time of the display non-uniformity compensation of the display device) during the switching from the first display mode to the second display mode to be only equal to or shorter than the loading time t21 for the flash memory chip 30 to reload the stored display non-uniformity compensation data corresponding to the second display mode into the first storage unit 201A. Similarly, during the switching from the second display mode to the first display mode, the turn-off time of the display non-uniformity compensation of the second display mode (i.e., the turn-off time of the display non-uniformity compensation of the display device) can be controlled to be only equal to or shorter than the loading time t11 for the flash memory chip 30 to reload the stored display non-uniformity compensation data corresponding to the first display mode into the first storage unit 201A. Thus, by controlling the turn-off time of the display non-uniformity compensation of the display device 000 to be within the loading time for the storage unit to reload the display non-uniformity compensation data corresponding to another display mode, the turn-off time of the display non-uniformity compensation can be shortened to less than 40 ms, which weakens the visual effect difference during the mode switching phase to a certain extent, achieves seamless switching as much as possible, and improves user experience.

In some embodiments, as shown in FIG. 13 and FIG. 15, the display method for the display device includes: before switching from the first display mode to the second display mode (that is, in the first display mode): acquiring, by the display driver chip 20, the display non-uniformity compensation data corresponding to the first display mode stored in the first storage unit 201A according to the to-be-displayed image of the display panel 10, to perform display non-uniformity compensation on the display image of the display panel 10; acquiring, by the display driver chip 20, the lifetime aging compensation data corresponding to the first display mode stored in the second storage unit 201B according to the to-be-displayed image of the display panel 10, to perform lifetime aging compensation on the display image of the display panel 10.

Then, the process of switching from the first display mode to the second display mode includes: obtaining a mode switching instruction; turning off the display non-uniformity compensation of the first display mode and turning off the lifetime aging compensation of the first display mode; loading, by the flash memory chip 30, the stored display non-uniformity compensation data corresponding to the second display mode into the first storage unit 201A; turning on the display non-uniformity compensation of the second display mode, and acquiring, by the display driver chip 20, the display non-uniformity compensation data corresponding to the second display mode stored in the first storage unit 201A according to the to-be-displayed image of the display panel 10, to perform display non-uniformity compensation on the display image of the display panel 10; loading, by the flash memory chip 30, the stored lifetime aging compensation data corresponding to the second display mode into the second storage unit 201B; and turning on the lifetime aging compensation of the second display mode, and acquiring, by the display driver chip 20, the lifetime aging compensation data corresponding to the second display mode stored in the second storage unit 201B according to the to-be-displayed image of the display panel 10, to perform lifetime aging compensation on the display image of the display panel 10; and completing the switching from the first display mode to the second display mode.

The display method for the display device provided in the embodiments ensures that during the mutual switching between the first display mode and the second display mode, after obtaining the mode switching instruction and turning off both the display non-uniformity compensation and lifetime aging compensation of the first display mode, the space of the first storage unit 201A is released preferentially. The display non-uniformity compensation data corresponding to the second display mode is retrieved from the flash memory chip 30 and loaded into the first storage unit 201A with released space, and then the display non-uniformity compensation of the second display mode is turned on immediately. That is, the turn-off time of the display non-uniformity compensation of the display device is only equal to the loading time for the flash memory chip 30 to retrieve and load the display non-uniformity compensation data corresponding to the second display mode into the first storage unit 201A with released space. After ensuring that the display non-uniformity compensation of the second display mode is turned on, the space of the second storage unit 201B is released, and the lifetime aging compensation data corresponding to the second display mode is retrieved from the flash memory chip 30 and loaded into the second storage unit 201B with released space. The lifetime aging compensation of the second display mode is then turned on to complete the switching from the first display mode to the second display mode. In the display method of the embodiments, the turn-off time of the display non-uniformity compensation of the display device is equivalent to the loading time for the flash memory chip 30 to retrieve and load the display non-uniformity compensation data corresponding to the second display mode into the first storage unit 201A with released space, which can theoretically shorten the turn-off time of the display non-uniformity compensation to a certain extent, weaken the visual effect difference during the switching phase, and improve display quality.

In some embodiments, as shown in FIG. 13 and FIG. 15, after turning off the display non-uniformity compensation of the first display mode and turning off the lifetime aging compensation of the first display mode, and before the flash memory chip 30 loads the stored display non-uniformity compensation data corresponding to the second display mode into the first storage unit 201A, the display method further includes: releasing the display non-uniformity compensation data corresponding to the first display mode stored in the first storage unit 201A. Then, after turning on the display non-uniformity compensation of the second display mode, and before the flash memory chip 30 loads the stored lifetime aging compensation data corresponding to the second display mode into the second storage unit 201B, the display method further include: releasing the lifetime aging compensation data corresponding to the first display mode originally stored in the second storage unit 201B. That is, the data release operations can be performed in a sequence where one storage unit follows another one storage unit. Although the data release process is extremely fast and almost negligible, releasing the display non-uniformity compensation data corresponding to the first display mode originally stored in the first storage unit 201A can preferentially ensure that the display non-uniformity compensation data corresponding to the second display mode is loaded into the first storage unit 201A as soon as possible, the display non-uniformity compensation process of the second display mode is turned on promptly, which further shortens the turn-off time of the display non-uniformity compensation of the display device, and better guarantees the effect of seamless switching.

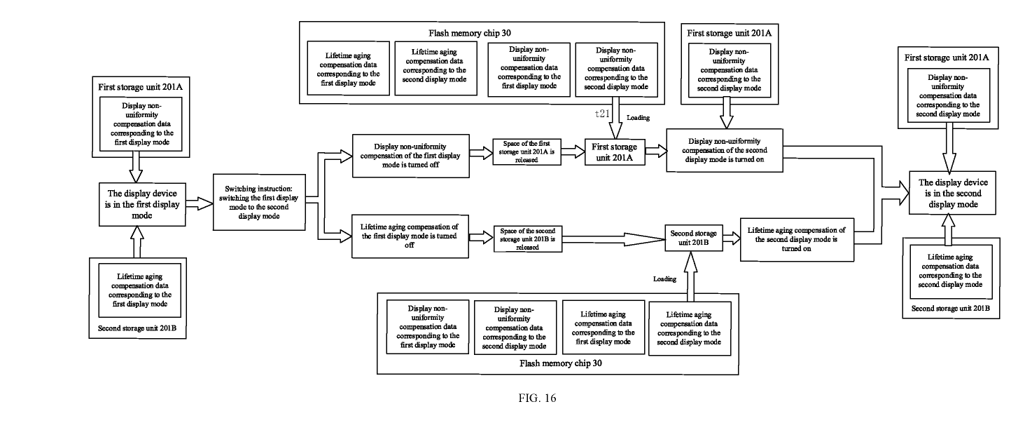

In some embodiments, as shown in FIG. 13 and FIG. 16, where FIG. 16 is another schematic diagram of a flow of the display method shown in FIG. 13, after turning off the display non-uniformity compensation of the first display mode and turning off the lifetime aging compensation of the first display mode, and before the flash memory chip 30 loads the stored display non-uniformity compensation data corresponding to the second display mode into the first storage unit 201A, the display method further includes: releasing the display non-uniformity compensation data corresponding to the first display mode stored in the first storage unit 201A, and releasing the lifetime aging compensation data corresponding to the first display mode stored in the second storage unit 201B. That is, the data release operations can be performed simultaneously by two storage units. Although the data release process is extremely fast and almost negligible, releasing the originally stored data in the first storage unit 201A and the second storage unit 201B simultaneously can further shorten the duration of the transition phase of mode switching, which is conducive to better guaranteeing the effect of seamless switching.

In some embodiments, please continue to refer to FIG. 1, FIG. 3, FIG. 8 and FIG. 10, the display device performs displaying by adopting the display method according to any one of the foregoing embodiments. The display device 000 of the embodiments may be an intelligent display product such as a mobile phone, or other display devices with a display function such as a computer, a television, or an in-vehicle display device, which is not specifically limited herein. When the display device 000 provided in the embodiments of the present disclosure performs display by adopting the display method according to any one of the foregoing embodiments, it has the beneficial effects of the display method provided in the foregoing embodiments. For details, reference may be made to the specific descriptions of the display method in the foregoing embodiments, which will not be repeated herein.

It should be noted that in this document, terms such as “first” and “second” are only used to distinguish one entity or operation from another entity or operation, and do not necessarily require or imply that there is any actual relationship or sequence between these entities or operations. Furthermore, the terms “include”, “contain”, or any other variation thereof are intended to cover a non-exclusive inclusion, such that a process, method, article, or device that includes a list of elements includes not only those elements but also other elements not expressly listed, or elements inherent to such a process, method, article, or device. Without further constraints, an element defined by the phrase “include a...” does not exclude the presence of additional identical elements in the process, method, article, or device that includes the element.

The above descriptions are merely specific implementations of the present disclosure, enabling those skilled in the art to understand or implement the present disclosure. Various modifications to these embodiments will be readily apparent to those skilled in the art, and the general principles defined herein may be implemented in other embodiments without departing from the spirit or scope of the present disclosure. Therefore, the present disclosure will not be limited to the embodiments described herein but is to be accorded the widest scope consistent with the principles and novel features disclosed herein.

What is claimed is:

1. A display method for a display device, wherein the display device has a first display mode and a second display mode, wherein display non-uniformity compensation data corresponding to the first display mode is different from display non-uniformity compensation data of the second display mode, wherein the display device comprises a display panel and a display driver chip, and wherein the display driver chip comprises a storage unit configured to store at least the display non-uniformity compensation data corresponding to the first display mode and the display non-uniformity compensation data corresponding to the second display mode;
wherein the display method comprises:
acquiring, by the display driver chip, the display non-uniformity compensation data corresponding to the first display mode and the display non-uniformity compensation data corresponding to the second display mode stored in the storage unit based on a to-be-displayed image of the display panel; and
performing display non-uniformity compensation on a display image of the display panel, wherein during a mutual switching process between the first display mode and the second display mode, turn-off time of the display non-uniformity compensation of the display device is less than 40 ms.

2. The display method according to claim 1, wherein the storage unit comprises a first storage unit and a second storage unit;
in the first display mode, the first storage unit is configured to store the display non-uniformity compensation data corresponding to the first display mode; and
in the second display mode, the first storage unit is configured to store the display non-uniformity compensation data corresponding to the second display mode.

3. The display method according to claim 2, wherein the display device further comprises a flash memory chip,
wherein the flash memory chip is configured to store the display non-uniformity compensation data corresponding to the first display mode and the display non-uniformity compensation data corresponding to the second display mode; and
a process of switching the first display mode to the second display mode comprises:
acquiring a mode switching instruction;
turning off the display non-uniformity compensation of the first display mode, and releasing the display non-uniformity compensation data corresponding to the first display mode stored in the first storage unit;
loading, by the flash memory chip, the stored non-uniformity compensation data corresponding to the second display mode into the first storage unit; and
turning on the display non-uniformity compensation of the second display mode, and acquiring, by the display driver chip, the display non-uniformity compensation data corresponding to the second display mode stored in the first storage unit based on the to-be-displayed image of the display panel, to perform display non-uniformity compensation on the display image of the display panel.

4. The display method according to claim 2, wherein
in the first display mode, the second storage unit is configured to store lifetime aging compensation data corresponding to the first display mode;
in the second display mode, the second storage unit is configured to store lifetime aging compensation data corresponding to the second display mode;
in the first display mode, the display method comprises:
acquiring, by the display driver chip, the display non-uniformity compensation data stored in the first storage unit based on the to-be-displayed image of the display panel, to perform display non-uniformity compensation on the display image of the display panel; and
acquiring, by the display driver chip, the lifetime aging compensation data stored in the second storage unit based on the to-be-displayed image of the display panel, to perform lifetime aging compensation on the display image of the display panel; and
in the second display mode, the display method comprises:
acquiring, by the display driver chip, the display non-uniformity compensation data stored in the first storage unit based on the to-be-displayed image of the display panel, to perform display non-uniformity compensation on the display image of the display panel; and
acquiring, by the display driver chip, the lifetime aging compensation data stored in the second storage unit based on the to-be-displayed image of the display panel, to perform lifetime aging compensation on the display image of the display panel.

5. The display method according to claim 1, wherein the storage unit comprises a first storage unit and a second storage unit;
in the first display mode, the first storage unit is configured to store the display non-uniformity compensation data corresponding to the first display mode; and
in the second display mode, the second storage unit is configured to store the display non-uniformity compensation data corresponding to the second display mode.

6. The display method according to claim 5, wherein the display device further comprises a flash memory chip configured to store the display non-uniformity compensation data corresponding to the first display mode and the display non-uniformity compensation data corresponding to the second display mode; and
a process of switching the first display mode to the second display mode comprises:
acquiring a mode switching instruction;
keeping the display non-uniformity compensation of the first display mode turned on;
loading, by the flash memory chip, the stored display non-uniformity compensation data corresponding to the second display mode into the second storage unit;
turning on the display non-uniformity compensation of the second display mode; and
acquiring, by the display driver chip, the display non-uniformity compensation data corresponding to the second display mode stored in the second storage unit based on the to-be-displayed image of the display panel, to perform display non-uniformity compensation on the display image of the display panel.

7. The display method according to claim 5, wherein:
in the first display mode, the second storage unit is configured to store lifetime aging compensation data corresponding to the first display mode;
in the second display mode, the first storage unit is configured to store lifetime aging compensation data corresponding to the second display mode;
in the first display mode, the display method comprises:
acquiring, by the display driver chip, the display non-uniformity compensation data stored in the first storage unit according to the to-be-displayed image of the display panel, to perform display non-uniformity compensation on the display image of the display panel; and
acquiring, by the display driver chip, the lifetime aging compensation data stored in the second storage unit according to the to-be-displayed image of the display panel, to perform lifetime aging compensation on the display image of the display panel; and
in the second display mode, the display method comprises:
acquiring, by the display driver chip, the display non-uniformity compensation data stored in the second storage unit according to the to-be-displayed image of the display panel, to perform display non-uniformity compensation on the display image of the display panel; and
acquiring, by the display driver chip, the lifetime aging compensation data stored in the first storage unit according to the to-be-displayed image of the display panel, to perform lifetime aging compensation on the display image of the display panel.

8. The display method according to claim 1, wherein the display device further comprises a first flash memory chip configured to store the display non-uniformity compensation data corresponding to the first display mode and the display non-uniformity compensation data corresponding to the second display mode, and a second flash memory chip configured to store lifetime aging compensation data corresponding to the first display mode and lifetime aging compensation data corresponding to the second display mode, and the storage unit comprises a first storage unit and a second storage unit;
wherein a process of switching the first display mode to the second display mode comprises:
loading, by the first flash memory chip, the stored display non-uniformity compensation data corresponding to the second display mode into the first storage unit; and simultaneously
loading, by the second flash memory chip, the stored lifetime aging compensation data corresponding to the second display mode into the second storage unit.

9. The display method according to claim 8, wherein:
loading time for the first flash memory chip to load the stored display non-uniformity compensation data corresponding to the second display mode into the first storage unit is defined as t1; and
loading time for the second flash memory chip to load the stored lifetime aging compensation data corresponding to the second display mode into the second storage unit is defined as t2,
where t1 < 40 ms and t2 < 40 ms.

10. The display method according to claim 8, wherein the process of switching the first display mode to the second display mode comprises:
obtaining a mode switching instruction;
turning off the display non-uniformity compensation of the first display mode and releasing the display non-uniformity compensation data corresponding to the first display mode stored in the first storage unit; and turning off lifetime aging compensation of the first display mode and releasing the lifetime aging compensation data corresponding to the first display mode stored in the second storage unit;
loading, by the first flash memory chip, the stored display non-uniformity compensation data corresponding to the second display mode into the first storage unit; and loading, by the second flash memory chip, the stored lifetime aging compensation data corresponding to the second display mode into the second storage unit;
turning on the display non-uniformity compensation of the second display mode; and acquiring, by the display driver chip, the display non-uniformity compensation data corresponding to the second display mode stored in the first storage unit according to the to-be-displayed image of the display panel, to perform display non-uniformity compensation on the display image of the display panel; and
turning on the lifetime aging compensation of the second display mode; and acquiring, by the display driver chip, the lifetime aging compensation data corresponding to the second display mode stored in the second storage unit according to the to-be-displayed image of the display panel, to perform lifetime aging compensation on the display image of the display panel; and
completing the switching from the first display mode to the second display mode.

11. The display method according to claim 10, wherein before switching the first display mode to the second display mode, i.e., in the first display mode, the display method comprises:
acquiring, by the display driver chip, the display non-uniformity compensation data corresponding to the first display mode stored in the first storage unit according to the to-be-displayed image of the display panel, to perform display non-uniformity compensation on the display image of the display panel; and
acquiring, the display driver chip, the lifetime aging compensation data corresponding to the first display mode stored in the second storage unit according to the to-be-displayed image of the display panel, to perform the lifetime aging compensation on the display image of the display panel.

12. The display method according to claim 1, wherein during the mutual switching process between the first display mode and the second display mode, the turn-off time of the display non-uniformity compensation of the display device is equal to 0.

13. The display method according to claim 1, wherein the display device further comprises a flash memory chip configured to store the display non-uniformity compensation data corresponding to the first display mode, the display non-uniformity compensation data corresponding to the second display mode, lifetime aging compensation data corresponding to the first display mode, and lifetime aging compensation data corresponding to the second display mode; and the storage unit comprises a first storage unit and a second storage unit;
wherein a process of switching the first display mode to the second display mode comprises:
obtaining a mode switching instruction;
keeping the display non-uniformity compensation of the first display mode turned on, turning off lifetime aging compensation of the first display mode, and releasing the lifetime aging compensation data corresponding to the first display mode stored in the second storage unit;
loading, by the flash memory chip, the stored display non-uniformity compensation data corresponding to the second display mode into the second storage unit; and
turning on the display non-uniformity compensation of the second display mode, and acquiring, by the display driver chip, the display non-uniformity compensation data corresponding to the second display mode stored in the second storage unit according to the to-be-displayed image of the display panel, to perform display non-uniformity compensation on the display image of the display panel.

14. The display method according to claim 13, wherein the process of switching the first display mode to the second display mode further comprises:
turning off the display non-uniformity compensation of the first display mode, releasing the display non-uniformity compensation data corresponding to the first display mode stored in the first storage unit, and loading, by the flash memory chip, the stored lifetime aging compensation data corresponding to the second display mode into the first storage unit;
turning on lifetime aging compensation of the second display mode, and acquiring, by the display driver chip, the lifetime aging compensation data corresponding to the second display mode stored in the first storage unit according to the to-be-displayed image of the display panel, to perform lifetime aging compensation on the display image of the display panel; and
completing the switching from the first display mode to the second display mode.

15. The display method according to claim 13, wherein before switching the first display mode to the second display mode, i.e., in the first display mode, the display method comprises:
acquiring, by the display driver chip, the display non-uniformity compensation data corresponding to the first display mode stored in the first storage unit according to the to-be-displayed image of the display panel, to perform display non-uniformity compensation on the display image of the display panel;
acquiring, by the display driver chip, the lifetime aging compensation data corresponding to the first display mode stored in the second storage unit according to the to-be-displayed image of the display panel, to perform lifetime aging compensation on the display image of the display panel.

16. The display method according to claim 1, wherein the display device further comprises a flash memory chip configured to store the display non-uniformity compensation data corresponding to the first display mode, the display non-uniformity compensation data corresponding to the second display mode, lifetime aging compensation data corresponding to the first display mode, and lifetime aging compensation data corresponding to the second display mode, and the storage unit comprises a first storage unit and a second storage unit;
wherein loading time for the flash memory chip to load the stored display non-uniformity compensation data corresponding to the first display mode into the first storage unit is defined as t11; loading time for the flash memory chip to load the stored display non-uniformity compensation data corresponding to the second display mode into the first storage unit is defined as t21; and during the mutual switching process between the first display mode and the second display mode, the turn-off time of the display non-uniformity compensation of the display device is defined as t3, where t3 ≤ t11; or, t3 ≤ t21.

17. The display method according to claim 16, wherein a process of switching the first display mode to the second display mode comprises:
obtaining a mode switching instruction;
turning off the display non-uniformity compensation of the first display mode, and turning off lifetime aging compensation of the first display mode;
loading, by the flash memory chip, the stored display non-uniformity compensation data corresponding to the second display mode into the first storage unit;
turning on the display non-uniformity compensation of the second display mode; and acquiring, by the display driver chip, the display non-uniformity compensation data corresponding to the second display mode stored in the first storage unit according to the to-be-displayed image of the display panel, to perform display non-uniformity compensation on the display image of the display panel;
loading, by the flash memory chip, the stored lifetime aging compensation data corresponding to the second display mode into the second storage unit;
turning on the lifetime aging compensation of the second display mode; and acquiring, by the display driver chip, the lifetime aging compensation data corresponding to the second display mode stored in the second storage unit according to the to-be-displayed image of the display panel, to perform lifetime aging compensation on the display image of the display panel; and
completing the switching from the first display mode to the second display mode.

18. The display method according to claim 17, wherein after turning off the display non-uniformity compensation of the first display mode and turning off the lifetime aging compensation of the first display mode, and before loading, by the flash memory chip, the stored display non-uniformity compensation data corresponding to the second display mode into the first storage unit, the display method further comprises:
releasing the display non-uniformity compensation data corresponding to the first display mode stored in the first storage unit, and releasing the lifetime aging compensation data corresponding to the first display mode stored in the second storage unit.

19. The display method according to claim 17, wherein after turning off the display non-uniformity compensation of the first display mode and turning off the lifetime aging compensation of the first display mode, and before loading, by the flash memory chip, the stored display non-uniformity compensation data corresponding to the second display mode into the first storage unit, the display method further comprises:
releasing the display non-uniformity compensation data corresponding to the first display mode stored in the first storage unit,
wherein after turning on the display non-uniformity compensation of the second display mode, and before loading, by the flash memory chip, the stored lifetime aging compensation data corresponding to the second display mode into the second storage unit, the display method further comprises:
releasing the lifetime aging compensation data corresponding to the first display mode stored in the second storage unit.

20. The display method according to claim 1, wherein the first display mode is one of a shared display mode or a privacy protection display mode, and the second display mode is the other one of the shared display mode or the privacy protection display mode.
